(19) United States
(12) Patent Application Publication
(10) Pub. No.: US 2010/0167978 A1
(43) Pub. Date: Jul. 1, 2010

(54) ALL SURFACE CLEANER PROTECTOR

(75) Inventors: Suresh IYER, Woodbury, MN (US); Chetan P. Jariwala, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/648,349

(22) Filed: Dec. 29, 2009

Related U.S. Application Data
(60) Provisional application No. 61/141,148, filed on Dec. 29, 2008.

(51) Int. Cl. C11D 1/62; C11D 1/38

(52) U.S. Cl. 510/433; 510/405

(57) ABSTRACT

A cleaning/protecting solution is provided comprising: a) 90-99.5% by weight of a solvent mixture comprising: i) 70-99% by weight water; and ii) 1%-30% by weight of a water-miscible alcohol; and b) 0.5-10% by weight of a fluorinated quaternary silane. In some embodiments, the cleaning solution additionally comprises: c) 0.1-5% by weight of a non-ionic surfactant. In some embodiments, the cleaning solution comprises no ionic surfactant. In some embodiments, the cleaning solution additionally comprises: d) 0.1-5% by weight of a non-fluorinated quaternary silane.

### CROSS REFERENCE TO RELATED APPLICATION

This application claims the benefit of U.S. Provisional Patent Application No. 61/141,148, filed on Dec. 29, 2008, the disclosure of which is incorporated by reference herein in its entirety.

### FIELD OF THE DISCLOSURE

This disclosure relates to compositions comprising water deliverable fluorinated quaternary silanes and, in some embodiments, a mixture of fluorinated and non-fluorinated quaternary silanes useful as all surface cleaner/protectors.

### BACKGROUND OF THE DISCLOSURE

Pat. App. No. US2008/077195, filed Sep. 22, 2008, Publication No. 2009/045771, published Apr. 9, 2009 (Atty Docket No. 63100WO003), and Pat. App. No. US2008/078240, filed Sep. 30, 2008, Publication No. 2009/045993, published Apr. 9, 2009 (Atty Docket No. 63665WO003), the disclosures of which are incorporated herein by reference, may be relevant to the present disclosure.

U.S. Pat. No. 6,461,537 B1 may be relevant to the present disclosure.

### SUMMARY OF THE DISCLOSURE

Briefly, the present disclosure provides a cleaning solution comprising: a) 90-99.5% by weight of a solvent mixture comprising: i) 70-99% by weight water; and ii) 1%-30% by weight of a water-miscible alcohol; and b) 0.5-10% by weight of a fluorinated quaternary silane. In some embodiments, the cleaning solution comprises 1-5% by weight of the fluorinated quaternary silane. In some embodiments, the cleaning solution additionally comprises: c) 0.1-5% by weight of a non-ionic surfactant. In some embodiments, the cleaning solution comprises no ionic surfactant. In some embodiments, the cleaning solution additionally comprises: d) 0.1-5% by weight of a non-fluorinated quaternary silane. In some embodiments, the cleaning solution additionally comprises a propellant.

In some embodiments, the fluorinated quaternary silane is a compound according to Formula I:

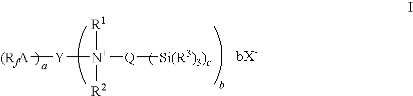

wherein a, b, and c are each independently an integer from 1 to 3; R_{f} is a perfluorinated ether group; A is a linking group having the formula —C_{d}H_{2d}ZC_{g}H_{2g}—, wherein d and g are independently integers from 0 to 10 and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group; Y is a bridging group having 1 to 10 carbon atoms, a valency from 2 to 6, and comprising at least one of an alkylene group or an arylene group; Q is a connecting group having 1 to 10 carbon atoms, a valency from 2 to 6, and comprising at least one of an alkylene group or an arylene group; R¹ and R² are independently selected from the group consisting of a hydrogen atom, an alkyl group, an aryl group, and an aralkyl group; each R³ is independently selected from the group consisting of hydroxy groups, alkoxy groups, acyl groups, acyloxy groups, halo groups, and polyether groups; and X⁻ is a counter ion selected from the group consisting of inorganic anions, organic anions, and combinations thereof.

In some embodiments, the fluorinated quaternary silane is a compound according to Formula III:

F(CF(CF₃)CF₂O)ₐCF(CF₃)—C(O)—NHCH₂CH₂CH₂—N⁺(CH₃)₂—CH₂CH₂Si(OCH₃)₃Cl⁻ (III)

wherein a is between 2 and 10.

In some embodiments, the non-fluorinated quaternary silane is a compound according to Formula II:

R⁴—{—N⁺(R¹)(R²)-Q-[—Si(R³)₃]_{c}}_{b}bX⁻ (II)

wherein b and c are each independently an integer from 1 to 3; R₄ is a selected from the group consisting of an alkyl group, an aryl group, an aralkyl group and a polyether group; Q is a connecting group having 1 to 10 carbon atoms, a valency from 2 to 6, and comprising at least one of an alkylene group or an arylene group; R¹ and R² are independently selected from the group consisting of a hydrogen atom, an alkyl group, an aryl group, and an aralkyl group; each R³ is independently selected from the group consisting of hydroxy groups, alkoxy groups, acyl groups, acyloxy groups, halo groups, and polyether groups; and X⁻ is a counter ion selected from the group consisting of inorganic anions, organic anions, and combinations thereof.

### DETAILED DESCRIPTION

The present disclosure provides compositions comprising water deliverable fluorinated quaternary silanes and, in some embodiments, a mixture of fluorinated and non-fluorinated quaternary silanes useful as all surface cleaner protectors (ASCP's). In some embodiments, the compositions according to the present invention additionally comprise a non-ionic surfactant. In some embodiments, the compositions according to the present invention comprise no ionic surfactant. These compositions exhibited excellent cleanability and in addition created a durable protection layer on surface of substrates. They are water deliverable and easy to apply.

The fluorinated quaternary silanes useful in the present disclosure may be compounds of Formula I:

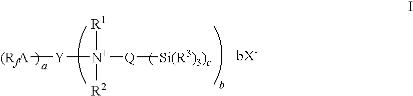

wherein a, b, and c are each independently an integer from about 1 to about 3; R_{f} is a perfluorinated ether group; A is a linking group having the formula —C_{d}H_{2d}ZC_{g}H_{2g}—, wherein d and g are independently integers from about 0 to about 10 and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group; Y is a bridging group having about 1 to about 10 carbon atoms, a valency from about 2 to about 6, and comprising at least one of an alkylene group or an arylene group; Q is a connecting group having about 1 to about 10 carbon atoms, a valency from about 2 to about 6, and comprising at least one of an alkylene group or an arylene group; R¹ and R² are independently selected from the group consisting of a hydrogen atom, an alkyl group, an aryl group, and an aralkyl group; each R³ is independently selected from the group consisting of hydroxy groups, alkoxy groups, acyl groups, acyloxy groups, halo groups, and polyether groups; and X⁻ is a counter ion selected from the group consisting of inorganic anions, organic anions, and combinations thereof.

The non-fluorinated quaternary silanes useful in the present disclosure may be compounds of Formula II:

R⁴—{—N⁺(R¹)(R²)-Q-[—Si(R³)₃]_{c}}_{b}bX⁻ (II)

wherein b and c are each independently an integer from about 1 to about 3; R₄ is a selected from the group consisting of an alkyl group, an aryl group, an aralkyl group and a polyether group; Q is a connecting group having about 1 to about 10 carbon atoms, a valency from about 2 to about 6, and comprising at least one of an alkylene group or an arylene group; R¹ and R² are independently selected from the group consisting of a hydrogen atom, an alkyl group, an aryl group, and an aralkyl group; each R³ is independently selected from the group consisting of hydroxy groups, alkoxy groups, acyl groups, acyloxy groups, halo groups, and polyether groups; and X⁻ is a counter ion selected from the group consisting of inorganic anions, organic anions, and combinations thereof.

The compositions of the present disclosure offer a high level of cleaning while leaving behind a low surface energy protective surface. The protective surface should lead to keeping the surface cleaner longer resulting in less cleaning being necessary. The compositions of the present disclosure may be useful in cleaning and protecting glass, polymer, ceramic, metal, or finished wood surfaces and the like, which may include appliances, consumer electronic devices, screens, windows, windshields, picture frame glass, and the like.

In some embodiments, the compositions of the present disclosure are delivered in a spray cleaner. In some embodiments, the compositions of the present disclosure are delivered in an aerosol. In some embodiments, the compositions of the present disclosure are delivered together with propellant, such as carbon dioxide, isobutane, propane and the like or combinations thereof. In some embodiments, the compositions of the present disclosure are delivered in pad or wipe. In some embodiments, the compositions of the present disclosure are delivered together with a biocide, fungicide, or the like. In some embodiments, the compositions of the present disclosure are delivered together with a fragrance or the like.

Objects and advantages of this invention are further illustrated by the following examples, but the particular materials and amounts thereof recited in these examples, as well as other conditions and details, should not be construed to unduly limit this invention.

### Examples

Unless otherwise noted, all reagents were obtained or are available from Aldrich Chemical Co., Milwaukee, Wis., USA, or may be synthesized by known methods.

### GLOSSARY LIST

Unless otherwise noted, as used in the examples, “HFPO—” refers to the end group F(CF(CF₃)CF₂O)ₐCF(CF₃)— of the methyl ester F(CF(CF₃)CF₂O)ₐCF(CF₃)C(O)OCH₃, wherein a averages about 6.67, with an average molecular weight of 1285 g/mol, can be prepared according to the method reported in U.S. Pat. No. 3,250,808 (Moore et al.), the disclosure of which is incorporated herein by reference, with purification by fractional distillation. HFPO Quat Silane was prepared as reported in U.S. Pat. App. No. 2008/077195, filed Sep. 22, 2008, the disclosure of which is incorporated herein by reference. 3-Chloropropyltrimethoxy silane (APTMS) and N,N-Dimethylpropylamine were obtained from Sigma-Aldrich of Milwaukee, Wis.
“HQ”—HFPO Quat Silane, synthesized as described below, having the following structure where optionally one or more methoxy groups may be replaced by —OH groups:

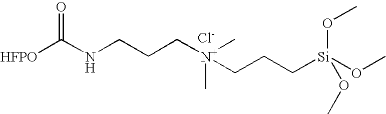

“DQ”—Dow Corning 9-6346 silane (available from Dow Chemical Co., Midland, Mich., USA) which contains the following chemicals (per MSDS):

| CAS Number | Wt % | Component Name |
|---|---|---|
| 27668-52-6 | >60.0 | Octadecyldimethyl trimethoxysilylpropyl |
| | | ammonium chloride |
| | | 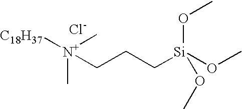 |
| 2530-87-2 | 15.0-40.0 | Chloropropyltrimethoxysilane |
| 67-56-1 | 10.0-30.0 | Methyl alcohol |
| 124-28-7 | 1.0-5.0 | Dimethyl octadecylamine |

Tergitol™ Surfactants “TS-15-S15”, “TS-15-S40”, “TS-15-S5”, and “TMN-6” (Dow Chemical, Danbury, Conn., USA available from Brenntag).
“DPS”—“Dehypound® Advanced” nonionic surfactant (Cognis Corporation, Cincinnati, Ohio, USA)
3M™ Novec™ Fluorosurfactants FC 4430 and FC 4432 obtained from 3M Company, St Paul, Minn., USA.
“IPA”—isopropyl alcohol
“Water”—distilled water

### Synthesis of HFPO Quat Silane (“HQ”)

HFPO quat silane (“HQ”) was prepared as shown in the following scheme:

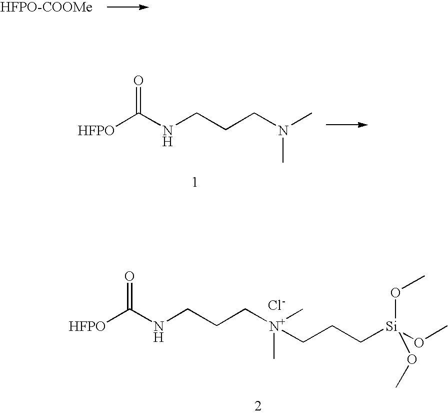

### Synthesis of 1:

A 500 mL round bottom flask was equipped with magnetic stir bar and charged with HFPO monomethyl ester (100 g, 0.0789 moles) and N,N-dimethylpropylamine (8.1 g, 0.0789 moles). The mixture was heated to 75° C. for 12 h and the reaction was monitored by IR for the disappearance of C═O peak and appearance of NH—C═O peak (@ 1725 cm⁻¹). The reaction mixture was concentrated by rotary evaporation at 45° C. to give a clear viscous solution and was analyzed by ¹H NMR.

### Synthesis of 2:

A 50 mL round bottom flask was equipped with magnetic stir bar and charged with 1 (1 g, 0.00075 moles) and 3-chlorotrimethoxypropylsilane (0.148 g, 0.00075 moles) and heated to 140° C. for 12 h under N₂ atmosphere. The sample was analyzed by ¹H NMR. 2 was used to make formulations as shown in Table 1.

### Preparation of ASCP Compositions

Compositions No. 1C (Comparative), 13C (Comparative), 2-12 and 14-20 were prepared by mixing the reagents listed in Table 1. Composition 1C was a comparative composition, which was Klear® Screen (Meridew Enterprises, Danville Calif., USA). Water was added finally and the compositions were transferred into spray bottles, shaken for 2 minutes and stored at room temperature.

TABLE 1
ASCP composition contents and concentration

| | Formulation (wt in grams) | | | | | | | | | |
|---|---|---|---|---|---|---|---|---|---|---|
| | | | TS- | TS- | | TS- | | | | |
| | | | 15- | 15- | | 15- | | | Water | |
| No. | HQ | DQ | S15 | S40 | DPS | S5 | TMN-6 | IPA | (g) | Total (g) |
| 1C | Klear ® Screen (Comparative) | | | | | | | | | |
| 2 | 0.5 | 0 | 0 | 0 | 0 | 0 | 0 | 2.5 | 47 | 50 |
| 3 | 2.5 | 0 | 0 | 0 | 0 | 0 | 0 | 2.5 | 45 | 50 |
| 4 | 0.5 | 0 | 0 | 0 | 0 | 0 | 0 | 12.5 | 37 | 50 |
| 5 | 0.5 | 0 | 0 | 0 | 0 | 0.5 | 0 | 2.5 | 46.5 | 50 |
| 6 | 2.5 | 0 | 0 | 0 | 0 | 0.5 | 0 | 2.5 | 44.5 | 50 |
| 7 | 0.5 | 0 | 0 | 0 | 0 | 0.5 | 0 | 10 | 39 | 50 |
| 8 | 0.5 | 0 | 0 | 0 | 0 | 0 | 0.5 | 2.5 | 46.5 | 50 |
| 9 | 2.5 | 0 | 0 | 0 | 0 | 0 | 0.5 | 2.5 | 44.5 | 50 |
| 10 | 0.5 | 0 | 0 | 0 | 0 | 0 | 0.5 | 10 | 39 | 50 |
| 11 | 0.5 | 0 | 0 | 0 | 0 | 0.5 | 0 | 25 | 24 | 50 |
| 12 | 0.5 | 0 | 0 | 0 | 0 | 0 | 0.5 | 25 | 24 | 50 |
| 13C | 0 | 0.5 | 0 | 0 | 0 | 0 | 0 | 2.5 | 47 | 50 |
| 14 | 0.5 | 0.13 | 0 | 0 | 0.1 | 0 | 0 | 2.5 | 46.75 | 51 |
| 15 | 0.5 | 0.25 | 0 | 0 | 0.3 | 0 | 0 | 2.5 | 46.5 | 51 |
| 16 | 0.5 | 0.38 | 0 | 0 | 0.4 | 0 | 0 | 2.5 | 46.25 | 50 |
| 17 | 0.5 | 0.5 | 0 | 0 | 0.5 | 0 | 0 | 2.5 | 46 | 50 |
| 18 | 0.5 | 0 | 0.5 | 0 | 0 | 0 | 0 | 2.5 | 46 | 49.5 |
| 19 | 0.5 | 0 | 0 | 0.5 | 0 | 0 | 0 | 2.5 | 46 | 49.5 |
| 20 | 0.5 | 0 | 0 | 0 | 0 | 0 | 0 | 49.5 | 0 | 50 |

### Contact Angle Measurements:

Substrates coated with compositions 1C-20 were rinsed with water (in case of plastics) and acetone (in case of glass), dried at room temperature and subjected to contact angle measurements. Contact angles were measured using a VCA-2500XE video contact angle apparatus. Results are shown in the tables 2 and 3. Reported values are averages of measurements on the different sides of at least three drops. Drop volumes were 5 microliters for static measurements, and 1-3 microliters for advancing and receding measurements.

TABLE 2
Average static water contact angle comparison between comparative
compositions and compositions of this disclosure:

| Composition | FILM | Water CA | | | Hexadecane |
|---|---|---|---|---|---|
| No. | Sample# | Static | Adv | Rec | Static |
| 1C | 1C | 84.55 | 92.40 | 56.75 | NA |
| 2 | 2 | 103.88 | 103.20 | 64.63 | 62.53 |
| 3 | 3 | 99.22 | 99.87 | 65.90 | 66 |
| 4 | 4 | NA | NA | NA | 65 |
| 5 | 5 | 83.35 | 91.88 | 52.98 | 64 |
| 6 | 6 | 98.20 | 98.30 | 55.00 | 69.98 |
| 7 | 7 | 90.52 | 94.90 | 59.88 | 61.54 |
| 8 | 8 | 74.43 | 87.35 | 57.75 | 49.27 |
| 9 | 9 | 96.82 | 99.65 | 61.37 | 58.04 |
| 10 | 10 | 88.13 | 95.57 | 56.57 | 44.46 |
| 11 | 11 | 65.27 | 73.07 | 54.52 | 38.54 |
| 12 | 12 | 75.22 | 83.02 | 50.48 | 26.43 |
| 13C | 13C | 80.98 | 84.47 | 52.50 | 38.06 |
| 14 | 14 | 87.47 | 103.73 | 50.80 | 52.83 |
| 15 | 15 | 85.78 | 88.62 | 49.47 | 41.69 |
| 16 | 16 | 82.88 | 85.75 | 62.22 | 56.67 |
| 17 | 17 | 81.65 | 83.70 | 62.23 | 38.20 |
| 18 | 18 | 85.70 | 93.60 | 58.60 | 48.14 |
| 19 | 19 | 91.48 | 96.17 | 58.62 | 55.11 |
| 20 | 20 | 94.42 | 98.12 | 67.23 | 61.50 |

TABLE 3
Average static water contact angle comparison between comparative
compositions and compositions of this disclosure when coated
on a glass substrate:

| | GLASS | Water CA | | | Hexadecane |
|---|---|---|---|---|---|
| Composition No. | Sample # | Static | Adv | Rec | Static |
| 1C | 31C | 66.05 | 64.82 | 38.23 | 20.58 |
| 2 | 32 | 111.35 | 110.78 | 75.85 | 67.22 |
| 3 | 33 | 112.82 | 112.33 | 71.75 | 66.15 |
| 4 | 34 | 109.58 | 110.90 | 73.28 | 66.50 |
| 5 | 35 | 102.63 | 106.37 | 67.37 | 67.22 |
| 6 | 36 | 109.23 | 108.38 | 62.10 | 66.93 |
| 7 | 37 | 104.10 | 108.88 | 66.37 | 62.28 |
| 8 | 38 | 101.05 | 100.33 | 57.63 | 69.72 |
| 9 | 39 | 103.45 | 104.03 | 61.28 | 69.68 |
| 10 | 40 | 96.20 | 96.70 | 58.32 | 72.55 |
| 11 | 41 | 103.45 | 107.30 | 62.95 | 74.31 |
| 12 | 42 | 108.38 | 106.87 | 67.50 | 72.17 |
| 13C | 43 | 87.88 | 93.58 | 52.77 | 19.15 |
| 14 | 44 | 93.33 | 100.85 | 68.12 | 56.82 |
| 15 | 45 | 98.60 | 101.18 | 72.75 | 58.72 |
| 16 | 46 | 97.52 | 89.87 | 50.08 | 59.42 |
| 17 | 47 | 87.88 | 95.05 | 59.50 | 55.65 |
| 18 | 48 | 100.77 | 103.80 | 65.83 | 71.46 |
| 19 | 49 | 97.05 | 97.57 | 69.42 | 64.73 |
| 20 | 50 | 99.35 | 103.47 | 77.82 | 63.78 |

### Cleaning/Protecting Comparison:

The substance indicated in Table 4 was applied liberally to a ⅝″ roughened rubber stopper, which was then pressed against the substrate, in order to simulate a very soiled fingerprint. The substrate surfaces were previously untreated. The compound was then applied with a single pump of its spray bottle. A clean dry Kimwipe was then rubbed on the substrate in a circular motion for 8 seconds. The substrate was then wiped again with another clean dry Kimwipe for another 8 seconds in a circular motion. The substrate was then visually inspected at various angles against the light, so that any remaining residue or haze could be observed. The cleaning scores are summarized on Table 4.

For the laminate, which is opaque and much more difficult to judge for cleanliness, the visual inspection also included a rubber eraser being drawn lightly across the wiped area to observe any tracking in any remaining residue or haze.

### Score Definitions:

5=Cleaned completely
4=Cleaned mostly
3=Cleaned moderately
2=Cleaned slightly
1=Cleaned little, if any

### Substances:

Butter—ordinary salted butter, chilled
Honey—ordinary honey, room temperature
Oil—automotive oil, 10W-30

### Substrates:

### Film—Hardcoated TAC

Glass—2×3 microscope slides
Laminate—kitchen countertop plastic laminate

TABLE 4
Cleaning/Protecting comparison chart:

| | Butter | Butter | Butter | Honey | Honey | Honey | Motor | Oil |
|---|---|---|---|---|---|---|---|---|
| Composition | on | on | on | on | on | on | Oil on | on |
| No. | Film | Glass | Laminate | Film | Glass | Laminate | Film | Glass |
| 1C | 5 | 4 | 5 | 5 | 5 | 5 | 5 | 5 |
| 2 | 5 | 4 | 5 | 5 | 5 | 5 | 2 | 2 |
| 3 | 5 | 3 | 5 | 4 | 5 | 5 | 2 | 2 |
| 4 | 5 | 4 | 5 | 4 | 4 | 5 | 2 | 3 |
| 5 | 5 | 5 | 5 | 4 | 5 | 5 | 3 | 4 |
| 6 | 4 | 5 | 5 | 4 | 5 | 4 | 4 | 3 |
| 7 | 4 | 5 | 5 | 5 | 4 | 5 | 4 | 4 |
| 8 | 5 | 5 | 5 | 4 | 5 | 5 | 3 | 4 |
| 9 | 4 | 5 | 5 | 4 | 5 | 4 | 3 | 3 |
| 10 | 3 | 4 | 5 | 4 | 5 | 5 | 4 | 3 |
| 11 | 4 | 4 | 5 | 3 | 5 | 5 | 3 | 3 |
| 12 | 5 | 4 | 5 | 3 | 5 | 4 | 3 | 4 |
| 13C | 3 | 4 | 5 | 3 | 5 | 5 | 4 | 5 |
| 14 | 3 | 4 | 4 | 5 | 4 | 4 | 4 | 3 |
| 15 | 3 | 4 | 5 | 4 | 5 | 5 | 3 | 3 |
| 16 | 2 | 4 | 5 | 4 | 5 | 5 | 4 | 3 |
| 17 | 3 | 4 | 4 | 5 | 4 | 5 | 4 | 3 |
| 18 | 5 | 4 | 5 | 4 | 5 | 5 | 2 | 3 |
| 19 | 4 | 3 | 4 | 4 | 4 | 5 | 2 | 3 |
| 20 | 4 | 3 | 4 | 2 | 2 | 2 | 3 | 3 |

### Improved Surface Wettability:

Surface wettabilities and thus cleanabilities of the compositions were further enhanced by reformulating some of the selected candidates as elaborated in Table 5. Compositions containing TMN-6 at low levels such as 0.1 wt % exhibit higher wettabilities and lowest surface tension compared to HQ in water. Surface tension measurements were performed using a platinum plate in order to remove the hysteresis observed when using a glass plate. (due to the reaction of siloxane to glass). However the trend in surface tension measurements remained the same in both cases.

TABLE 5
Surface Tension of Selected Compositions

| | Formulation (wt in grams) | | | | | | Surface |
|---|---|---|---|---|---|---|---|
| Composition | | FC | FC- | | | Water | Tension |
| No. | HQ | 4432 | 4430 | TMN-6 | IPA | (g) | Dynes/Cm |
| 2A | 1 | 0 | 0 | 0 | 1 | 98 | 51.3 |
| 21 | 1 | 0 | 0 | 0.1 | 1 | 97.9 | 31.7 |
| 22 | 1 | 0.1 | 0 | 0 | 1 | 97.9 | 37.9 |
| 23 | 1 | 0 | 0.1 | 0 | 1 | 97.9 | 37.0 |

Various modifications and alterations of this invention will become apparent to those skilled in the art without departing from the scope and principles of this invention, and it should be understood that this invention is not to be unduly limited to the illustrative embodiments set forth hereinabove.

We claim:

1. A cleaning solution comprising:
a) 90-99.5% by weight of a solvent mixture comprising:
i) 70-99% by weight water; and
ii) 1%-30% by weight of a water-miscible alcohol; and
b) 0.5-10% by weight of a fluorinated quaternary silane.

2. The cleaning solution according to claim 1 comprising 1-5% by weight of the fluorinated quaternary silane.

3. The cleaning solution according to claim 1 additionally comprising:
c) 0.1-5% by weight of a non-ionic surfactant.

4. The cleaning solution according to claim 1 comprising no ionic surfactant.

5. The cleaning solution according to claim 1 additionally comprising:
d) 0.1-5% by weight of a non-fluorinated quaternary silane.

6. The cleaning solution according to claim 3 additionally comprising:
d) 0.1-5% by weight of a non-fluorinated quaternary silane.

7. The cleaning solution according to claim 1 wherein the fluorinated quaternary silane is a compound according to Formula I: 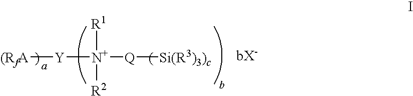
wherein a, b, and c are each independently an integer from 1 to 3; R_{f} is a perfluorinated ether group; A is a linking group having the formula —C_{d}H_{2d}ZC_{g}H_{2g}—, wherein d and g are independently integers from 0 to 10 and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group; Y is a bridging group having 1 to 10 carbon atoms, a valency from 2 to 6, and comprising at least one of an alkylene group or an arylene group; Q is a connecting group having 1 to 10 carbon atoms, a valency from 2 to 6, and comprising at least one of an alkylene group or an arylene group; R¹ and R² are independently selected from the group consisting of a hydrogen atom, an alkyl group, an aryl group, and an aralkyl group; each R³ is independently selected from the group consisting of hydroxy groups, alkoxy groups, acyl groups, acyloxy groups, halo groups, and polyether groups; and X⁻ is a counter ion selected from the group consisting of inorganic anions, organic anions, and combinations thereof.

8. The cleaning solution according to claim 1 wherein the fluorinated quaternary silane is a compound according to Formula III:
F(CF(CF₃)CF₂O)ₐCF(CF₃)—C(O)—NHCH₂CH₂CH₂—N⁺(CH₃)₂—CH₂CH₂Si(OCH₃)₃Cl⁻ (III)
wherein a is between 2 and 10.

9. The cleaning solution according to claim 5 wherein the non-fluorinated quaternary silane is a compound according to Formula II:
R⁴—{—N⁺(R¹)(R²)-Q-[—Si(R³)₃]_{c}}_{b}bX⁻ (II)
wherein b and c are each independently an integer from 1 to 3; R₄ is a selected from the group consisting of an alkyl group, an aryl group, an aralkyl group and a polyether group;
Q is a connecting group having 1 to 10 carbon atoms, a valency from 2 to 6, and comprising at least one of an alkylene group or an arylene group; R¹ and R² are independently selected from the group consisting of a hydrogen atom, an alkyl group, an aryl group, and an aralkyl group; each R³ is independently selected from the group consisting of hydroxy groups, alkoxy groups, acyl groups, acyloxy groups, halo groups, and polyether groups; and X⁻ is a counter ion selected from the group consisting of inorganic anions, organic anions, and combinations thereof.

10. The cleaning solution according to claim 1 additionally comprising a propellant.
